(19) United States
(12) Patent Application Publication
(10) Pub. No.: US 2009/0286004 A1
(43) Pub. Date: Nov. 19, 2009

(54) METHOD OF FORMING PRINTED CIRCUIT PATTERN, FORMING GUIDE FOR PATTERN, AND GUIDE-FORMING INK

(75) Inventors: Sung-Il OH, Seoul (KR); Jae-Woo JOUNG, Suwon-si (KR); Hyun-Chul JUNG, Yongin-si (KR); Sung-Nam CHO, Buyeo-gun (KR); In-Young KIM, Suwon-si (KR); Young-Ah SONG, Suwon-si (KR); Su-Hwan CHO, Seoul (KR); Hye-Jin CHO, Seoul (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: SAMSUNG ELECTRO-MECHANICS CO., LTD., Suwon (KR)

(21) Appl. No.: 12/346,081

(22) Filed: Dec. 30, 2008

(30) Foreign Application Priority Data
May 19, 2008 (KR) 10-2008-0046314

(51) Int. Cl. B05D 5/12; B32B 7/12

(52) U.S. Cl. 427/511; 524/186

(57) ABSTRACT

Disclosed are methods of forming a printed circuit pattern and forming a guide, and a guide-forming ink. The method of forming a printed circuit pattern in accordance with the present invention includes forming a guide by using guide-forming ink having a slip property, curing the formed guide by in-situ UV, and forming a printed circuit pattern on the inside of the cured guide by using metal ink.

### CROSS-REFERENCE TO RELATED APPLICATIONS

This application claims the benefit of Korean Patent Application No. 10-2008-0046314, filed with the Korean Intellectual Property Office on May 19, 2008, the disclosure of which is incorporated herein by reference in its entirety.

### BACKGROUND

1. Technical Field

The present invention relates to methods of forming a printed circuit pattern and forming a guide, and guide-forming ink.

2. Description of the Related Art

With the demand for an inexpensive method of manufacturing electronic devices, much attention has been given to an inexpensive process of forming a pattern, for example, a printing technology. Because the inkjet printing technology, among a number of printing technologies, does not require a plate making process and costs less, a number of studies devoted to manufacturing electronic devices through this inkjet printing technology are underway.

With the development of the nanotechnology, it has become possible to manufacture a printed circuit pattern through the inkjet printing technology using metal ink because Nano metal ink, with its excellent distribution stability, can be plastic at a temperature of as low as 200° C. Such inkjet printing technology can simplify the process of forming a printed circuit pattern and is useful in a small quantity batch production system.

However, a large amount of metal in the metal ink hinders stable distribution of the metal ink and proper discharge of inkjet in the inkjet printing technology. Due to the greater gravity than other solvents or organic matters in the ink, the metal that occupies over 50 percentage weight of the ink makes up the volume of 10% or less. Therefore, as a small amount of metal remains when forming a pattern, it becomes possible to form a pattern with a thickness of 1 μm or less.

The increasing demand for high density printed circuit boards necessary for smaller electronic devices mandates a much smaller volume of ink to be discharged, thereby further reducing the metal content of the ink and thus the thickness of the pattern.

However, the thinner pattern hampers the manufacture of a printed circuit board of high electric conductivity.

### SUMMARY

The present invention provides a method of forming a printed circuit pattern, a method of forming a guide and a guide-forming ink.

An aspect of the present invention features a method of forming a printed circuit pattern. The method of forming a printed circuit pattern in accordance with an embodiment of the present invention can include: forming a guide by using guide-forming ink having a slip property; curing the formed guide by in-situ UV; and forming a printed circuit pattern on the inside of the cured guide by using metal ink.

According to an embodiment, the guide-forming ink having the slip property can include a slip agent including at least one compound selected from a group consisting of a silicon compound, a hydrocarbon compound, a fluorine compound and an amide compound; and acrylic ink.

According to an embodiment, the silicon compound can be at least one compound selected from a group consisting of Polymethylalkylsiloxane, Dimethylpolysiloxane, Polyester-modified polymethylalkylsiloxane, Polyether-modified polymethylalkylsiloxane and Polyester-modified hydroxypolymethylsiloxane.

According to an embodiment, the amide compound can be at least one compound selected from a group consisting of Cis-13-docosenamide, Oleic amide and Erucyl amide.

According to an embodiment, the method can include the slip agent in the range from 0.01 to 20 weight % and the acrylic ink in the range from 80 to 99.99 weight %.

According to an embodiment, the forming the guide can be an inkjet printing method.

According to an embodiment, the forming the printed circuit pattern can be an inkjet printing method.

Another aspect of the present invention features a method of forming a guide for forming a printed circuit pattern. The method of forming a guide for forming a printed circuit pattern in accordance with an embodiment of the present invention can include: forming a guide by using guide-forming ink having a slip property; and curing the formed guide by in-situ UV.

According to an embodiment, the guide-forming ink having the slip property can include a slip agent including at least one compound selected from a group consisting of a silicon compound, a hydrocarbon compound, a fluorine compound and an amide compound; and acrylic ink.

According to an embodiment, the silicon compound can be at least one compound selected from a group consisting of Polymethylalkylsiloxane, Dimethylpolysiloxane, Polyester-modified polymethylalkylsiloxane, Polyether-modified polymethylalkylsiloxane and Polyester-modified hydroxypolymethylsiloxane.

According to an embodiment, the amide compound can be at least one compound selected from a group consisting of Cis-13-docosenamide, Oleic amide and Erucyl amide.

According to an embodiment, the method can include the slip agent in the range from 0.01 to 20 weight % and the acrylic ink in the range from 80 to 99.99 weight %.

According to an embodiment, the forming the guide can be an inkjet printing method.

Yet another aspect of the present invention features a guide-forming ink. The guide-forming ink in accordance with an embodiment of the present invention can include: a slip agent including at least one compound selected from a group consisting of a silicon compound, a hydrocarbon compound, a fluorine compound and an amide compound; and acrylic ink.

According to an embodiment, the silicon compound can be at least one compound selected from a group consisting of Polymethylalkylsiloxane, Dimethylpolysiloxane, Polyester-modified polymethylalkylsiloxane, Polyether-modified polymethylalkylsiloxane and Polyester-modified hydroxypolymethylsiloxane.

According to an embodiment, the amide compound can be at least one compound selected from a group consisting of Cis-13-docosenamide, Oleic amide and Erucyl amide.

According to an embodiment, the ink can include the slip agent in the range from 0.01 to 20 weight % and the acrylic ink in the range from 80 to 99.99 weight %.

### BRIEF DESCRIPTION OF THE DRAWINGS

FIG. 1 illustrates a flow of a method of forming a printed circuit pattern according to an embodiment of the present invention.

FIG. 2 illustrates a side view of a method of forming a guide according to an embodiment of the present invention.

FIG. 3 illustrates a side view of the inside of a guide formed according to an embodiment of the present invention.

FIG. 4 illustrates slip of metal ink on the surface of a guide cured according to an embodiment of the present invention.

FIG. 5A shows a top view of a printed circuit pattern according to an embodiment of the present invention.

FIG. 5B shows a cross section of the printed circuit pattern of FIG. 5A.

FIG. 6A shows a top view of a printed circuit pattern used in comparison.

FIG. 6B shows a cross section of the printed circuit pattern of FIG. 6A.

### DETAILED DESCRIPTION

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention. In the following description of the present invention, the detailed description of known technologies incorporated herein will be omitted when it may make the subject matter unclear.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

Hereinafter, certain embodiments of a method of forming a printed circuit pattern according to the present invention will be described in detailed with reference to the accompanying drawings. In description with reference to the accompanying drawings, same reference numerals will be assigned to the same or corresponding elements, and repetitive descriptions thereof will be omitted.

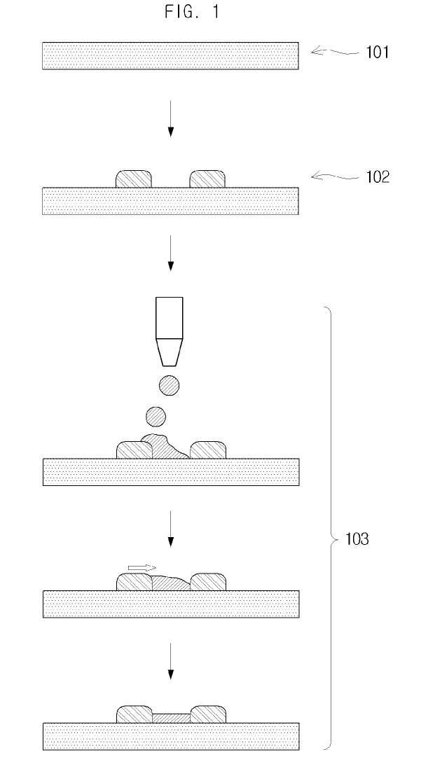

FIG. 1 illustrates a method of forming a printed circuit pattern in accordance with an embodiment of the present invention. The method can include a substrate resin preparation step 101, a guide formation step 102 and a printed circuit pattern formation step 103.

The substrate resin in the substrate resin preparation step 101 can be high-molecular resin. Epoxy resin, BT resin or polyimide resin, for example, can be used as the substrate resin. It shall be evident that the substrate resin is not limited to the above examples.

A guide for forming a printed circuit pattern is formed in the guide formation step 102.

Guide-forming ink 203 according to an exemplary embodiment of the present invention can be acrylic ink having a UV curing property. If the guide-forming ink is printed by means of the inkjet printing method, it is unnecessary to use a photolithography process or manufacture a separate mask so as to form a guide. Accordingly, the entire process can be simplified.

With the UV curing property of the ink, the ink becomes cured by an in-situ UV curing lamp 202 as soon as the ink adheres to the substrate resin after being discharged from an inkjet head 201, forming a high-resolution guide that is little spread out. Once the high-resolution guide is formed, it is possible to form a high-resolution printed circuit pattern, which has a large aspect ratio, i.e., a ratio of thickness to height as viewed from a side of the printed circuit pattern.

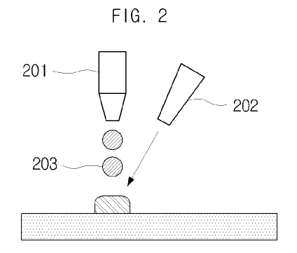

FIG. 2 illustrates the guide formation step 102 described above in more detail. As described above, the guide-forming ink 203 becomes cured by the in-situ UV curing lamp 202, which is adjacent to the inkjet head 201, as soon as the guide-forming ink 203 is discharged from the inkjet head 201.

The guide-forming ink 203 can have a slip property. In order for the ink to have the slip property, the guide-forming ink 203 according to an embodiment of the present invention can include a slip agent and acrylic ink that contain at least one compound selected from a group consisting of a silicon compound, a hydrocarbon compound, a fluorine compound and an amide compound.

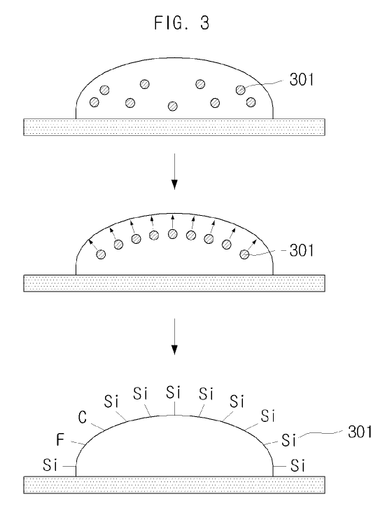

As illustrated in FIG. 3, since the slip agent 301 included in the guide-forming ink 203 is not very compatible with acrylic ink, which is a main component of the guide-forming ink 203, the slip agent rises to the surface of the guide during the curing after the printing. Accordingly, the surface of the guide is coated with the slip agent component. The slip agent 301 on the surface of the guide reduces the adhesive strength between the guide and metal ink by reducing a coefficient of friction of the surface of the guide. Therefore, if the metal ink is adhered on the guide, the metal ink slips and is adhered on the inside of the guide without adhering to the guide.

The slip property of the guide makes it possible to prevent resolution degradation of the printed circuit pattern, caused by the adhesion error of the metal ink. If the metal ink is repeatedly printed at one position in order to obtain a printed circuit pattern having a large thickness, it is difficult to adhere the ink to the inside of the guide precisely because of a processing variation among inkjet head nozzles, an error in movement of a stage and a head handler of inkjet equipment, the volume error or the straightness of the ink. When a guide according to an embodiment of the present invention is employed, the slip property of the guide causes the metal ink to move to the inside of the guide even though the metal ink does not adhere to the inside of the guide.

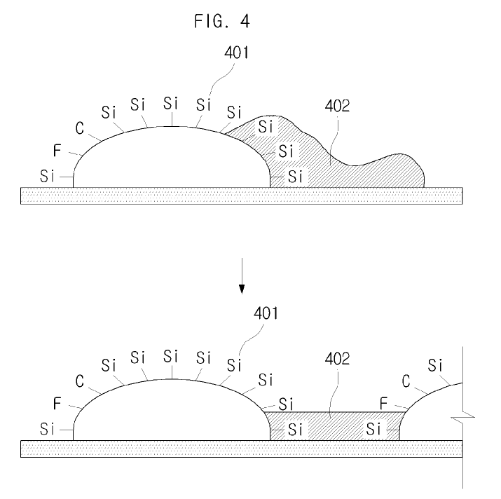

When metal ink 402 adheres to the surface of the guide as illustrated in FIG. 4, it can be seen that the slip property of the slip agent 401, which has risen to the surface of the guide, causes the metal ink 402 to move to the inside of the guide. Although the slip agent 301 of FIG. 3 and the slip agent 401 of FIG. 4 have different reference numerals from each other, they are the same element.

The silicon compound included in the guide-forming ink having the slip property can be at least one compound selected from a group consisting of Polymethylalkylsiloxane, Dimethylpolysiloxane, Polyester-modified polymethylalkylsiloxane, Polyether-modified polymethylalkylsiloxane and Polyester-modified hydroxypolymethylsiloxane. The silicon compound can be any one compound or a combination of two or more of the compounds.

The amide compound included in the guide-forming ink can be at least one compound selected from a group consisting of Cis-13-docosenamide, Oleic amide and Erucyl amide. The amide compound can be any one compound or a combination of two or more of the compounds.

The hydrocarbon compound included in the guide-forming ink can be at least one compound selected from a group consisting of a long alkyl chain compound and a carbon fiber derivative. The hydrocarbon compound can be any one sort in the group or a combination of two or more sorts in the group.

The fluorine compound included in the guide-forming ink can be a fluorine-substituted compound. The fluorine compound can be any one kind or two or more kinds among different kinds of fluorine-substituted compounds.

The guide-forming ink 203 can include 0.01 to 20% weight of the slip agent 401 and 80 to 99.99% weight of the acrylic ink. If less than 0.01% weight of the slip agent 401 is included, the surface of the guide loses the slip property. If more than 20% weight of the slip agent 401 is included, a phase segregation occurs between the slip agent and the acrylic ink within the guide-forming ink at the time of compounding the guide-forming ink, making it difficult, if not impossible, to discharge the ink by using the inkjet printing method.

The printed circuit pattern can be formed by printing the metal ink 402 inside the formed guide. As described above, even when the metal ink is printed repetitively inside the guide by using the inkjet printing method, a printed circuit pattern having a great thickness can be obtained without losing the resolution. The “great thickness” here refers to a high aspect ratio, which is a ratio of a thickness to a height, of the printed circuit pattern when the printed circuit pattern is seen from the side.

An inkjet printing method can be used for the method of printing the guide forming ink and the method of printing the metal ink. When the guide and the printed circuit pattern are directly formed through inkjet printing, the conventional processes of photolithography, including mask-plating, exposure, developing, etching, exfoliating and cleaning, can be eliminated, simplifying the entire process. Moreover, less amounts of organic solvents and organic wastewater are discharged, making the manufacturing of the printed circuit board environmentally friendly.

### Embodiment

After 350 g of 2-Hydroxyethylacrylate and 575 g of 2-Methacryloyloxyisocyanate are uniformly mixed at a temperature of 50° C. by using a high-speed agitator, 48.75 g of Azobisiso baleronitrile, 500 g of 3-Ethyl-3-(phenoxymethyl)oxetane, 20 g of Polymethylalkylsiloxane and 55 g of antifoaming agent are mixed to the above compound and then agitated at a high speed. The above compound is then filtered through a 1 μm filter to make guide-forming ink. Through the use of the guide-forming ink, a guide is formed by using the inkjet printing method, and metal ink is printed inside the guide by using the inkjet printing method. The printed circuit pattern is formed by firing the metal ink for one hour at a temperature of 200° C.

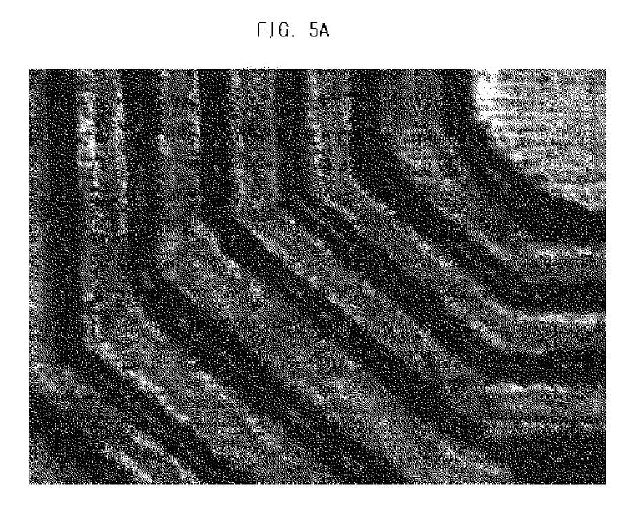

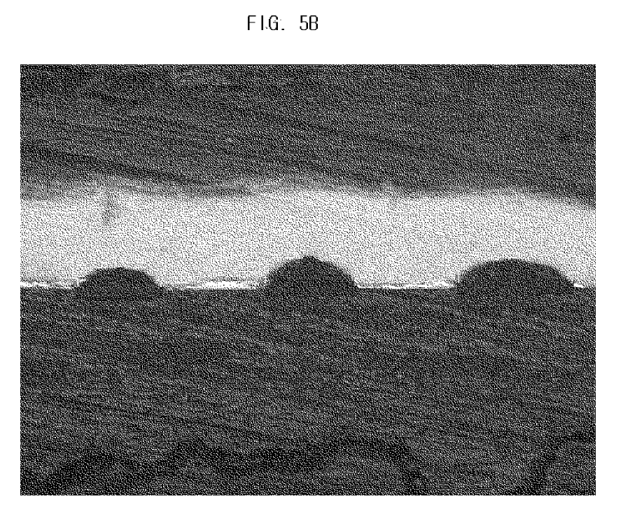

FIG. 5A shows the printed circuit pattern, obtained from the embodiment, seen from the top. FIG. 5B shows a cross section of the printed circuit pattern of FIG. 5A. As illustrated in FIGS. 5A and 5B, it can be seen that it is possible to obtain an excellent printed circuit pattern having very low tolerance in accordance with the present invention.

Comparison Example

After 350 g of 2-Hydroxyethylacrylate and 575 g of 2-Methacryloyloxyisocyanate are uniformly mixed at a temperature of 50° C. by using a high-speed agitator, 48.75 g of Azobisiso baleronitrile, 500 g of 3-Ethyl-3-(phenoxymethyl)oxetane and 75 g of antifoaming agent are mixed to the above compound and then agitated at a high speed. The above compound is then filtered through a 1 μm filter to make guide-forming ink. Through the use of the guide-forming ink, a guide is formed by using the inkjet printing method, and metal ink is printed inside the guide by using the inkjet printing method. The printed circuit pattern is formed by firing the metal ink for one hour at a temperature of 200° C.

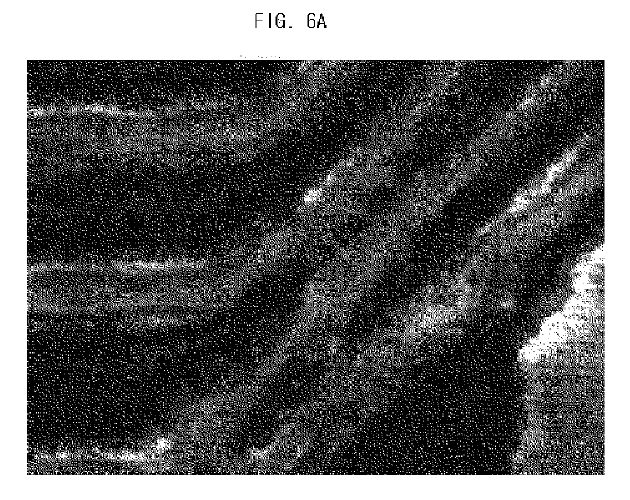

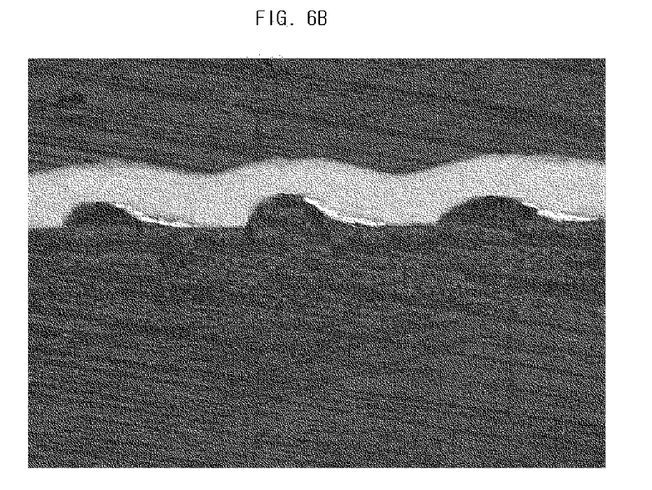

FIG. 6A shows the printed circuit pattern obtained from the comparison example, seen from the top. FIG. 6B shows a cross section of the printed circuit pattern of FIG. 6A. As illustrated in FIGS. 6A and 6B, as compared with the printed circuit pattern obtained from the embodiment, it can be seen that a part of the metal ink is cured on the surface of the guide and a poor result of a printed circuit pattern having high tolerance is obtained.

While the present invention has been described with reference to an embodiment thereof, it will be understood by those skilled in the art that various changes and modification in forms and details can be made without departing from the spirit and scope of the present invention as defined by the appended claims, and there can be a very large number of embodiments, other than what has been described hitherto, in the claims of the present invention.

What is claimed is:

1. A method of forming a printed circuit pattern, the method comprising:
forming a guide by using guide-forming ink having a slip property;
curing the formed guide by in-situ UV; and
forming a printed circuit pattern on the inside of the cured guide by using metal ink.

2. The method of claim 1, wherein the guide-forming ink having the slip property comprises:
a slip agent comprising at least one compound selected from a group consisting of a silicon compound, a hydrocarbon compound, a fluorine compound and an amide compound; and
acrylic ink.

3. The method of claim 2, wherein the silicon compound is at least one compound selected from a group consisting of Polymethylalkylsiloxane, Dimethylpolysiloxane, Polyester-modified polymethylalkylsiloxane, Polyether-modified polymethylalkylsiloxane and Polyester-modified hydroxypolymethylsiloxane.

4. The method of claim 2, wherein the amide compound is at least one compound selected from a group consisting of Cis-13-docosenamide, Oleic amide and Erucyl amide.

5. The method of claim 2, wherein the guide-forming ink comprises 0.01% to 20% slip agent by weight and 80% to 99.99% acrylic ink by weight.

6. The method of claim 3, wherein the guide-forming ink comprises 0.01% to 20% slip agent by weight and 80% to 99.99% acrylic ink by weight.

7. The method of claim 4, wherein the guide-forming ink comprises 0.01% to 20% slip agent by weight and 80% to 99.99% acrylic ink by weight.

8. The method of claim 1, wherein the forming of the guide is performed by an inkjet printing method.

9. The method of claim 1, wherein the forming of the printed circuit pattern is performed by an inkjet printing method.

10. A method of forming a guide for forming a printed circuit pattern, the method comprising:
forming a guide by using guide-forming ink having a slip property; and
curing the formed guide by in-situ UV.

11. The method of claim 10, wherein the guide-forming ink having the slip property comprises:
a slip agent comprising at least one compound selected from a group consisting of a silicon compound, a hydrocarbon compound, a fluorine compound and an amide compound; and
acrylic ink.

12. The method of claim 11, wherein the silicon compound is at least one compound selected from a group consisting of Polymethylalkylsiloxane, Dimethylpolysiloxane, Polyester-modified polymethylalkylsiloxane, Polyether-modified polymethylalkylsiloxane and Polyester-modified hydroxypolymethylsiloxane.

13. The method of claim 11, wherein the amide compound is at least one compound selected from a group consisting of Cis-13-docosenamide, Oleic amide and Erucyl amide.

14. The method of claim 11, wherein the guide-forming ink comprises 0.01% to 20% slip agent by weight and 80% to 99.99% acrylic ink by weight.

15. The method of claim 12, wherein the guide-forming ink comprises 0.01% to 20% slip agent by weight and 80% to 99.99% acrylic ink by weight.

16. The method of claim 13, wherein the guide-forming ink comprises 0.01% to 20% slip agent by weight and 80% to 99.99% acrylic ink by weight.

17. The method of claim 10, wherein the forming of the guide is performed by an inkjet printing method.

18. A guide-forming ink comprising:
a slip agent comprising at least one compound selected from a group consisting of a silicon compound, a hydrocarbon compound, a fluorine compound and an amide compound; and
acrylic ink.

19. The guide-forming ink of claim 18, wherein the silicon compound is at least one compound selected from a group consisting of Polymethylalkylsiloxane, Dimethylpolysiloxane, Polyester-modified polymethylalkylsiloxane, Polyether-modified polymethylalkylsiloxane and Polyester-modified hydroxypolymethylsiloxane.

20. The guide-forming ink of claim 18, wherein the amide compound is at least one compound selected from a group consisting of Cis-13-docosenamide, Oleic amide and Erucyl amide.

21. The guide-forming ink of claim 18, wherein the guide-forming ink comprises 0.01% to 20% slip agent by weight and 80% to 99.99% acrylic ink by weight.

22. The guide-forming ink of claim 19, wherein the guide-forming ink comprises 0.01% to 20% slip agent by weight and 80% to 99.99% acrylic ink by weight.

23. The guide-forming ink of claim 20, wherein the guide-forming ink comprises 0.01% to 20% slip agent by weight and 80% to 99.99% acrylic ink by weight.
